(19) United States
(12) Patent Application Publication
(10) Pub. No.: US 2019/0122498 A1
(43) Pub. Date: Apr. 25, 2019

(54) GAMING MACHINE AND METHOD COMPRISING MULTIPLE JACKPOTS

(71) Applicant: Atlas Gaming Technologies Pty Ltd, Port Melbourne (AU)

(72) Inventors: Daniel Julio Montenegro, Port Melbourne (AU); Zenja Solaja, Port Melbourne (AU); Boris Mitelman, Port Melbourne (AU); Wade Gregory Clark, Port Melbourne (AU)

(21) Appl. No.: 16/039,883

(22) Filed: Jul. 19, 2018

(30) Foreign Application Priority Data
Oct. 25, 2017 (AU) 2017904328

(51) Int. Cl. G07F 17/32; G06Q 50/34

(52) U.S. Cl. CPC G07F 17/3258; G06Q 50/34; G07F 17/3211

(57) ABSTRACT

Embodiments generally relate to a gaming machine, comprising at least one processor; memory storing executable program code; at least one display to display game-related images; and input components to receive player input. The at least one processor is configured to execute the program code to implement and display at least two denomination-specific jackpots and at least one shared jackpot to a user on a first area of the at least one display; display at least two bet denominations to the user, each bet denomination corresponding to at least one of the at least two denomination-specific jackpots; in response to receiving first input from the user, determine one bet denomination to be a selected bet denomination; determine at least one denomination specific-jackpot corresponding to the one bet denomination to be a first selected jackpot; in response to receiving second input from the user, display a game of chance on a second area of the at least one display while simultaneously displaying the at least two denomination-specific jackpots and the at least one shared jackpot to a user on the first area of the at least one display; in response to determining a denomination-specific jackpot-winning game outcome, award the user the selected jackpot; and in response to determining a shared jackpot-winning game outcome, award the user at least one shared jackpot.

### CROSS-REFERENCE TO RELATED APPLICATION

The present application claims priority from Australian Provisional Patent Application No. 2017904328, filed Oct. 25, 2017, the disclosure of which is hereby incorporated herein by reference.

### TECHNICAL FIELD

The present disclosure relates to an improved gaming machine and method for gaming.

### BACKGROUND

Gaming machines allow players to make bets on symbols that appear on the real or virtual reels, offering awards to players based on the combinations of symbols that appear. These games appeal to players as a way of winning cash or credits. Gaming machines sometimes include a jackpot value that may be won by the player. However, once the jackpot is won, it is reset to a lower “seed” level. Because of the lower jackpot, a player may not be motivated to continue playing at the same machine.

It is desired to address or ameliorate one or more shortcomings or disadvantages associated with prior methods, systems and machines for gaming, or to at least provide a useful alternative thereto.

Any discussion of documents, acts, materials, devices, articles or the like which has been included in the present specification is not to be taken as an admission that any or all of these matters form part of the prior art base or were common general knowledge in the field relevant to the present disclosure as it existed before the priority date of each claim of this application.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

### SUMMARY

Some embodiments relate to a gaming machine, comprising:
at least one processor;
memory storing executable program code;
at least one display to display game-related images; and input components to receive player input;
wherein the at least one processor is configured to execute the program code to:
implement and display at least two denomination-specific jackpots and at least one shared jackpot to a user on a first area of the at least one display;
display at least two bet denominations to the user, each bet denomination corresponding to at least one of the at least two denomination-specific jackpots;
in response to receiving first input from the user, determine one bet denomination to be a selected bet denomination;
determine at least one denomination specific-jackpot corresponding to the one bet denomination to be a first selected jackpot;
in response to receiving second input from the user, display a game of chance on a second area of the at least one display while simultaneously displaying the at least two denomination-specific jackpots and the at least one shared jackpot to a user on the first area of the at least one display;
in response to determining a denomination-specific jackpot-winning game outcome, award the user the selected jackpot; and
in response to determining a shared jackpot-winning game outcome, award the user at least one shared jackpot.

In some embodiments, receiving second input from the user comprises receiving a wager input from the user.

According to some embodiments, the gaming machine further comprises a currency acceptance mechanism and is configured to receive credit via the currency acceptance mechanism.

In some embodiments, the processor is further configured to use a portion of the wager to increment at least one denomination-specific jackpot, to implement the denomination-specific jackpot as a progressive jackpot. According to some embodiments, the processor is further configured to use a portion of the wager to increment at least one shared jackpot, to implement the shared jackpot as a progressive jackpot. In some embodiments, the processor is further configured to use a portion of the wager to increment at least one seed value corresponding to at least one shared or denomination-specific jackpot.

According to some embodiments, in response to awarding the user the selected jackpot, the processor is further configured to set the jackpot value of the selected jackpot to the seed value corresponding to the selected jackpot.

According to some embodiments, in response to awarding the user at least one shared jackpot, the processor is further configured to set the jackpot value of the at least one shared jackpot to the seed value corresponding to the at least one shared jackpot.

In some embodiments, the at least one display comprises two displays, where the first area of the at least one display is located on a first display of the two displays and the second area of the at least one display is located on a second display of the two displays.

In some embodiments the at least two denomination-specific jackpots comprise three denomination-specific jackpots and the at least two bet denominations comprise three bet denominations. According to some embodiments, the at least two denomination-specific jackpots comprise four denomination-specific jackpots and the at least two bet denominations comprise four bet denominations.

Some embodiments relate to a computer implemented method of operating a gaming machine, the method comprising:
implementing and displaying at least two denomination-specific jackpots and at least one shared jackpot to a user on a first area of at least one display on the gaming machine;
displaying at least two bet denominations to the user, each bet denomination corresponding to at least one of the at least two denomination-specific jackpots;
in response to receiving input from the user, determining one bet denomination to be a selected bet denomination;
determining at least one denomination specific-jackpot corresponding to the one bet denomination to be a first selected jackpot;
in response to receiving input from the user, displaying a game of chance on a second area of the at least one display while simultaneously displaying the at least two denomination-specific jackpots and the at least one shared jackpot to a user on the first area of the at least one display;
in response to determining a denomination-specific jackpot-winning game outcome, awarding the player the selected jackpot; and
in response to determining a shared jackpot-winning game outcome, awarding the player at least one shared jackpot.

In some embodiments, receiving second input from the user comprises receiving a wager from the user. Some embodiments further comprise receiving credit via a currency acceptance mechanism.

Some embodiments further comprise using a portion of the wager to increment at least one denomination-specific jackpot, to implement the denomination-specific jackpot as a progressive jackpot. Some embodiments further comprise using a portion of the wager to increment at least one shared jackpot, to implement the shared jackpot as a progressive jackpot. Some embodiments further comprise using a portion of the wager to fund at least one seed value corresponding to at least one shared or denomination-specific jackpot.

Some embodiments further comprise, in response to awarding the user the selected jackpot, setting the jackpot value of the selected jackpot to the seed value corresponding to the selected jackpot.

Some embodiments further comprise, in response to awarding the user at least one shared jackpot, setting the jackpot value of the at least one shared jackpot to the seed value corresponding to the at least one shared jackpot.

According to some embodiments, the at least one display comprises two displays, where the first area of the at least one display is located on a first display of the two displays and the second area of the at least one display is located on a second display of the two displays.

In some embodiments, the at least two denomination-specific jackpots comprise three denomination-specific jackpots and the at least two bet denominations comprise three bet denominations. In some embodiments, the at least two denomination-specific jackpots comprise four denomination-specific jackpots and the at least two bet denominations comprise four bet denominations.

Some embodiments relate to a non-transitory computer-readable medium storing machine-readable instructions to cause a processor of a gaming machine to perform the method of various embodiments described herein.

### BRIEF DESCRIPTION OF DRAWINGS

Embodiments are described below in further detail and by way of example, with reference to the accompanying drawing, in which:

FIG. 1 is a diagrammatic representation of a gaming system in accordance with some embodiments, implemented in the form of a stand-alone gaming machine;

FIG. 2 is a schematic block diagram of core components of the gaming system of FIG. 1;

FIG. 3 is a schematic diagram of a gaming system in accordance with some embodiments, with the gaming system implemented over a network;

FIG. 4 is a schematic block diagram of the software components of a gaming system according to some embodiments;

FIG. 5 is a flow diagram illustrating a method of controlling game play on a gaming machine according to some embodiments;

FIG. 6 is an example screen shot showing a jackpot screen when a 1c bet is placed;

FIG. 7 is an example screen shot showing a jackpot screen when a 2c bet is placed;

FIG. 8 is an example screen shot showing a jackpot screen when a 5c bet is placed;

FIG. 9 is a further example screen shot showing a jackpot screen when a 5c bet is placed;

FIG. 10 is a further example screen shot showing a jackpot screen when a 1c bet is placed;

FIG. 11 is an example screenshot showing a jackpot being won when a 1c bet has been placed; and

FIG. 12 is an example screenshot showing a jackpot screen after a jackpot has been won from a 1c bet having been placed.

### DETAILED DESCRIPTION

The present disclosure relates to an improvement to a gaming machine and an improved method of game play on a gaming machine.

When playing a gaming machine that allows the player to select a denomination, the gaming machine may display a jackpot value that is proportional to the bet being placed by the player. Gaming machines may be configured to operate in this way in order to comply with jurisdictional requirements. However, only one jackpot is displayed to a player at any given time. Given that the player can only play a single denomination at a time, the jackpot value displayed will reflect the appropriate jackpot value for the denomination being played.

The reason for this is that jurisdictional requirements limit the number of jackpots available on a given machine. For example, in New South Wales, a gaming machine has a limit of 4 jackpots. If it is desired to present a major and a minor jackpot to the player, and there are 3 denominations available to the player to select, this would be a total of 6 jackpots in the gaming machine, which would not be allowed according to the jurisdictional rules.

In some gaming machines, jackpot meters are shared across all denominations, so that all jackpots are available regardless of what denomination is being played. In this case, no matter what denomination is played, all of the jackpots are always displayed. However, there is no visible advantage for the player to try playing a different or higher denomination. Once a player has won a jackpot and the jackpot amount has been reseeded, they are likely to want to move on to a different gaming machine to attempt to win a jackpot that has been incremented above the seed amount.

Some gaming machines implement denomination-dependent bonus prizes. For example, a bonus prize of $100.00 may be displayed on a top box of a gaming machine while playing a 1c bet/denomination game, for example. If player switches to a 2c denomination, the bonus prize may be changed to $200.00, for example. If the machine is displaying a denomination selection screen, the bonus prizes might rotate to display all of the available bonus prizes to the player.

In contrast to the previously described examples, the present application relates to a gaming machine that allows multiple separate jackpots to be displayed at the same time, with each jackpot relating to a different denomination, along with displaying a major jackpot that is shared across all denominations. When one jackpot is won, the player can still see the other available jackpots and is motivated to keep playing at a different denomination, to try to win a second or third jackpot. The player also has the ability to win either a major or a minor jackpot, adding interest to the game. The jackpots are progressive jackpots, so that each bet the player places results in an increment to one or more of the jackpots.

This adds interest to the jackpots available in a multi-denomination machine, by differentiating jackpot values between different denominations, and by giving the players an opportunity to see that other jackpots are still available after one of the jackpots has been won. Since a jackpot for a higher denomination is likely to be higher than a lower denomination jackpot, a player is motivated to play a higher denomination to attempt to win a higher reward.

Described embodiments generally relate to a gaming system. The gaming system can take a number of different forms. In a first form, a stand-alone gaming machine is provided wherein all or most components required for implementing the game are present in a player operable gaming machine.

In a second form, a distributed architecture is provided wherein some of the components required for implementing the game are present in a player operable gaming machine and some of the components required for implementing the game are located remotely relative to the gaming machine. For example, a “thick client” architecture may be used wherein part of the game is executed on a player operable gaming machine and part of the game is executed remotely, such as by a gaming server; or a “thin client” architecture may be used wherein most of the game is executed remotely such as by a gaming server and a player operable gaming machine is used only to display audible and/or visible gaming information to the player and receive gaming inputs from the player.

However, it will be understood that other arrangements are envisaged. For example, an architecture may be provided wherein a gaming machine is networked to a gaming server and the respective functions of the gaming machine and the gaming server are selectively modifiable. For example, the gaming system may operate in standalone gaming machine mode, “thick client” mode or “thin client” mode depending on the game being played, operating conditions, and so on.

Irrespective of the form, the gaming system 100 has several core components. At the broadest level, the core components comprise a player interface and a game controller. The player interface is arranged to enable interaction between a player and the gaming system and for this purpose includes input/output components required for the player to enter instructions and play the game. For example, the input/output components may include a credit mechanism to enable a player to input credits and receive payouts, one or more displays which may comprise a touch screen, and a game play mechanism arranged to enable a player to input game playing instructions. The game controller is in data communication with the player interface and typically comprises a processor arranged to process game play instructions and output game player outcomes to the one or more displays. It will be understood that in the present specification, the term “processor” refers generally to any device that can process game play instructions and may include a microprocessor, microcontroller, programmable logic device or any computational device such as a personal computer or a server.

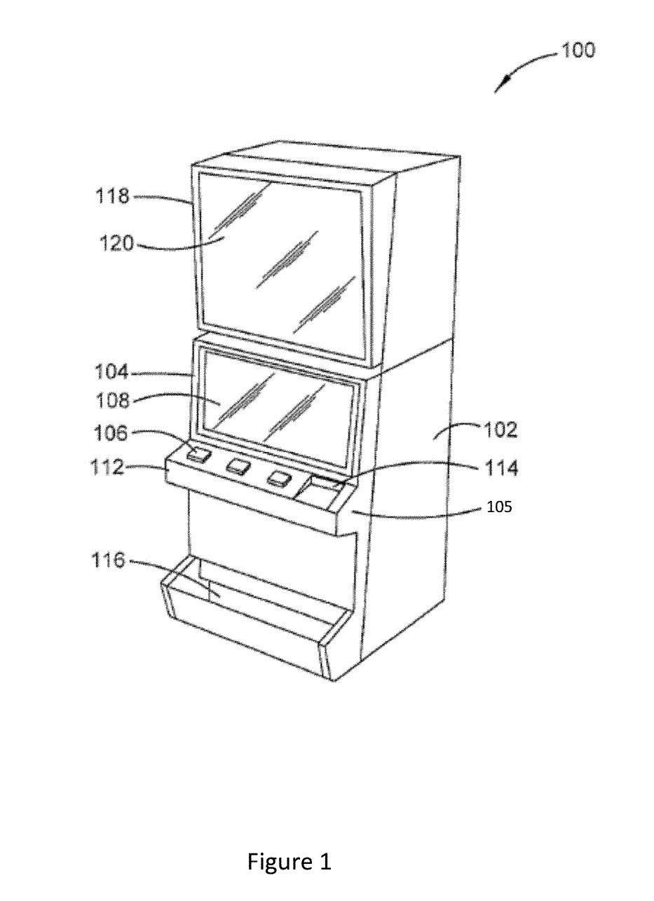

Referring now to FIG. 1, reference numeral 100 generally designates a stand-alone gaming system including a game. Hereinafter, the stand-alone gaming system 100 will be referred to as a gaming machine.

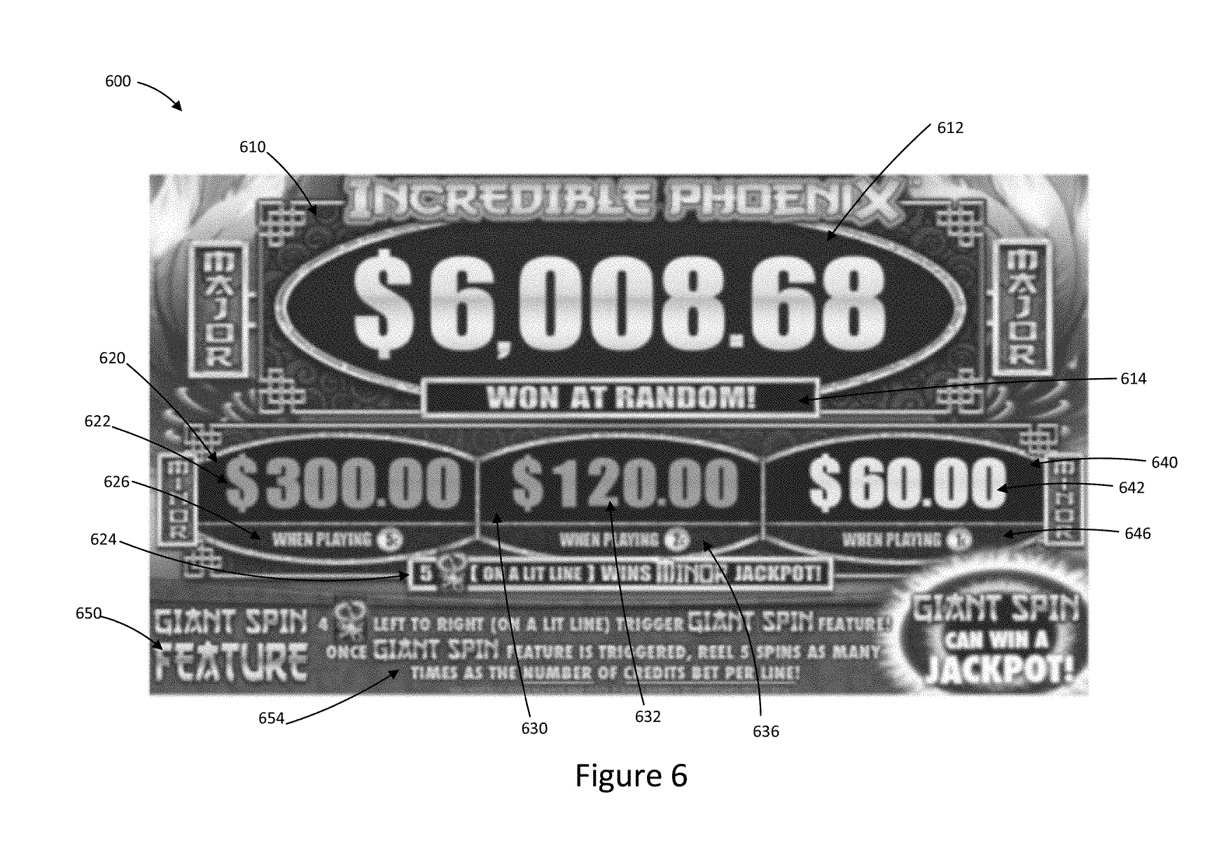

The gaming machine 100 includes a console 102 which contains all or most components required to implement a game play whereby, at least during part of the game play, a player wins or loses a wager. Access to the components is by way of a hinged door 105. Mounted to the exterior of the console 102 is a display means in the form of at least one visual display unit 104 on which one or more games is played, and at least one secondary display unit 120. Secondary display unit 120 may display artwork and advertising, as well as jackpot amounts, as illustrated in FIGS. 6 to 12 and described in further detail below. The units 104 and 120 may be implemented as a liquid crystal display, a plasma screen, or other high quality digital video display. What is displayed on the visual display unit 104 will depend on what the intended goal of the unit is in relation to the player and any other potential participants in the gaming system. In some embodiments, a plurality of gaming machines 100 may communicate with a central display screen (not shown), which may allow for portions of gameplay to be displayed to a wider audience in a gaming venue.

In this example, the gaming machine 100 includes a tactile input for a player to interact via touch with the gaming machine 100. The tactile input may be in the form of a combination of pushbuttons 106 and a touch screen 108 for enabling a player to play one or more games. The touch screen 108 is an electronic visual display that can detect the presence and location of a touch within the display area. The touch screen 108 may be used during game setup, user browsing, or during the game play between start of a game and the end of a game, for example. Certain functions of the pushbutton are: initiation of game play, credit output, gameplay selection, completion of gameplay etc. A midtrim 112 of the machine 100 houses the pushbuttons 106.

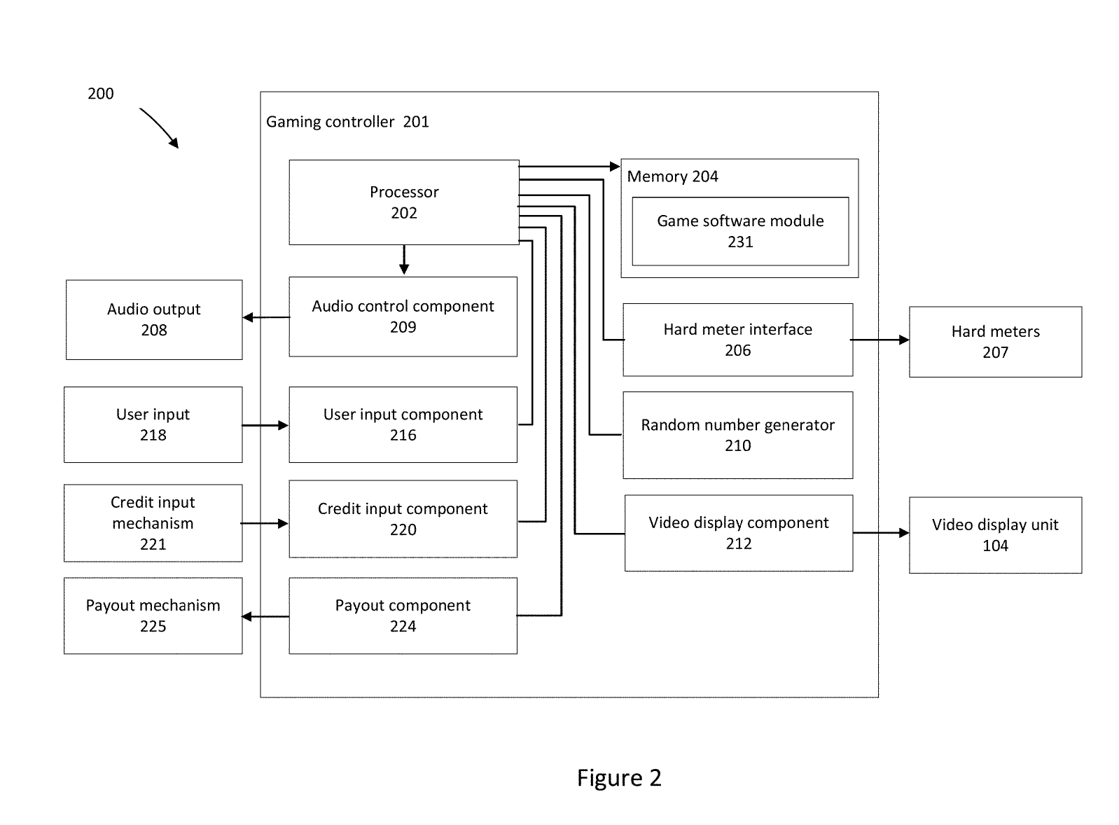

The tactile input may optionally or further include a joystick (not shown) comprising a stick that pivots on a base and reports its angle or direction to the device it is controlling. The tactile input may optionally or further include a trackpad/touchpad (not shown) being a pointing device featuring a tactile sensor to translate the motion and position of a user's fingers to a relative position on screen. In some embodiments, tactile input may further include a keyboard, electronic mouse, or other input mechanism. In some embodiments, the user interface may be a user configurable interface having multiple user input options. It should be appreciated that tactile input may include any suitable device that enables the player to produce an input signal that is received by the processor 202 (see FIG. 2).

The midtrim 112 may house a credit input mechanism 221 including a bill collector 114. The credit input mechanism 221 may alternatively or additionally include a coin input chute, a card and/or ticket reader, a magnetic reading head for reading a magnetic stripe card, an electronic reader for a proximity card, a near field communications reader or any other form of electronic, wireless or contact that can input credit to the gaming machine.

A payout mechanism 225 including a coin tray 116 may be mounted beneath the console 102 and is provided for cash or other payouts from the machine 100 to the player. A hopper device (not shown) is provided which dispenses coins, or tokens equal to the amount of credit currently on the machine, into the coin tray 116. Aside from the coin tray 116, payout mechanism 225 may alternatively or additionally include a ticket dispenser for issuing a ticket dispensed by a printer which the user can redeem for cash, a note dispenser, a near field communications transmitter or means to enable remote credit transfer. Other suitable payout mechanisms, such as fund transfers to the player's electronically recordable identification card or smart card, may be implemented in accordance with described embodiments.

The gaming machine 100 further includes an auditory unit in the form of auditory output 208 (see FIG. 2) to provide auditory feedback to the player of the gaming machine 100.

Referring to FIG. 2, game logic circuitry 200 is illustrated. The game logic circuitry 200 includes a gaming controller 201 (otherwise referred to as a logic cage). As will be appreciated by those skilled in the gaming industry, the logic cage 201 includes a box-like mechanical structure that has slots to guide logic cards into the proper location for electronically plugging into a backplane mounted at the rear of the cage structure. The logic cards may contain hardware configured to perform specific functions, and may include sound cards, video cards, network cards, hard drives or other memory storage. The backplane has connectors for accepting mating connectors on the logic cards. The logic cage 201 and associated logic cards form one of the basic components of the gaming machine 100 and is securely housed within the cabinet of the gaming machine 100.

Central to the logic cage 201 is a processor 202 which may be a central processing unit, a microcontroller-based platform, a suitable integrated circuit, or one or more application-specific integrated circuits (ASIC's).

In this particular example, the processor 202 is in communication with or operable to access or to exchange signals with: memory 204, an audio control component 209, a hard meter interface 206, a random number generator 210, a user input component 216, a video display component 212, a credit input component 220 and a payout component 224.

Instructions and data to control operation of the processor 202 are stored in a memory 204 which is in data communication with processor 202. Memory 204 typically comprises both volatile and non-volatile memory and more than one of each type of memory. For example, the memory 204 may comprise RAM, ROM, and non-volatile memory in the form of a memory card, such as compact flash. RAM may include non-volatile RAM (NVRAM), magnetic RAM (MRAM), ferroelectric RAM (FeRAM), and other forms as commonly understood in the gaming industry. Memory 204 comprises a game software module 231 storing executable code, which when executed by the processor 202, provides the game on the gaming machine 100.

In particular, processor 202 runs executable code residing in game software module 231 of memory 204 that facilitates play of a game by a player through display unit 104 and/or push buttons 106 and touch sensors 108 mounted in the screen of display unit 104. Game software module 231 contains executable program code that defines the rules of the game, defines the sequence of gameplay, communicates with external systems, monitors peripheral equipment, and maintains integrity of the software code, among other things.

Audio control component 209 is in communication with audio output 208. Audio control component 209 may have its own digital signal processor, analogue to digital converters, amplifiers and other circuitry necessary to broadcast the output from the speakers.

Hard meter interface 206 communicates with hard meters 207. Hard meters 207 contain the gaming machine parameters which are required to be stored on a hard meter for regulatory reasons, which may include values such as total credit in and total credit out in some jurisdictions, for example. The values in hard meters 207 are only ever incremented, and cannot be reset or decremented.

Random number generator 210 generates random or pseudo-random numbers for the purpose of determining the outcome of chance-based games played on gaming machine 100. In some embodiments, random number generator 210 may be implemented in software as part of game software module 231. In some other embodiments, random number generator 210 may be implemented in firmware or in hardware. In some embodiments, the form that random number generator 231 takes may be dictated by gaming regulations.

User input component 216 communicates with user inputs 218, which may include pushbuttons 106 and touch screen sensors 108, among other inputs. Received inputs are decoded by user input component 216 and communicated to processor 202.

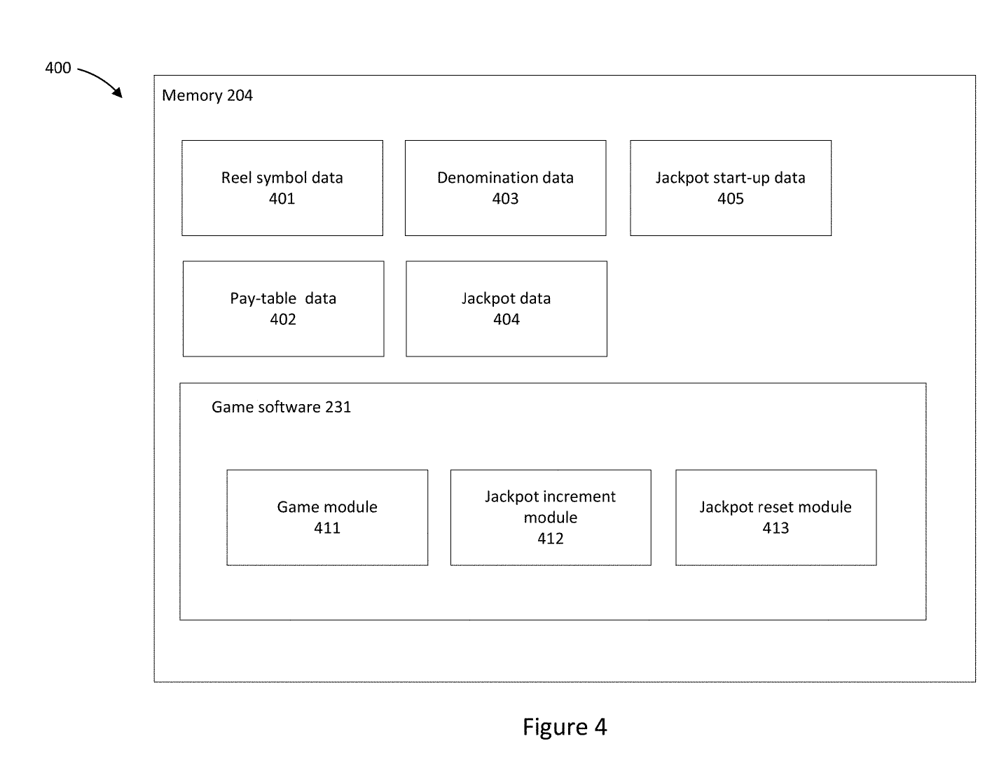

Video display component 212 communicates with video display unit 104. Processor 202 sends instructions to video display component 212, in order to cause images that make up the game sequence to be displayed on video display unit 104. These images may be pre-generated images retrieved by processor 202 from memory 204, or the images may be generated in real-time by processor 202 executing code modules stored in memory 204, as described below with reference to FIG. 4. In some embodiments, the displayed images may be made up of a pre-generated background retrieved from memory 204 in combination with an animated sequence generated in real-time by processor 202.

Credit input component 220 receives signals from credit input mechanism 221, which may include bill collector 114 in some embodiments. Credit input component 220 may use the signals to determine whether or not a player has provided sufficient credit to commence or continue gameplay, for example.

Payout component 224 communicates with payout mechanism 225, which may include coin tray 116. Payout component 224 may send instructions to payout mechanism 225, to cause payout mechanism 225 to dispense payment to a player. The payout may be in the form of cash, tokens or tickets in some embodiments. In some embodiments, the player may receive a code which they can use to collect their payout from a designated kiosk. In some embodiments, a player card or account may be credited with the payout amount. In some embodiments, a player may be able to finish game play and request a payout at various stages throughout the game. In some embodiments, players may be able to request a payout at any stage of the game. The player may be able to use user input 118 to request the payout.

In some embodiments, a player may insert an identification card or ticket into a card reader (not shown) of the gaming machine 100, in order to load information onto gaming machine 100. For example, the identification card or ticket may be associated with a player account containing credit, player settings, and player progress in a game. Such an identification card may be a smart card having a programmed microchip, a coded magnetic strip, or coded rewritable magnetic strip, wherein the programmed microchip or magnetic strips are coded with a player's identification, credit totals (or related data), and/or other relevant information. In another embodiment, a player may carry a portable device, such as a mobile phone, a radio frequency identification tag, or any other suitable wireless device, that communicates a player's identification, credit totals (or related data), and other relevant information to the gaming device.

One or more of the method steps described in this disclosure may be implemented by game software module 231 stored in memory 204. Instructions stored in game software module 231 may be executed by processor 202 or any other processor. Further, the processor 202, the memory 204, the game software module 231 stored therein, or a combination thereof, may serve as a means for performing one or more of the method steps described herein.

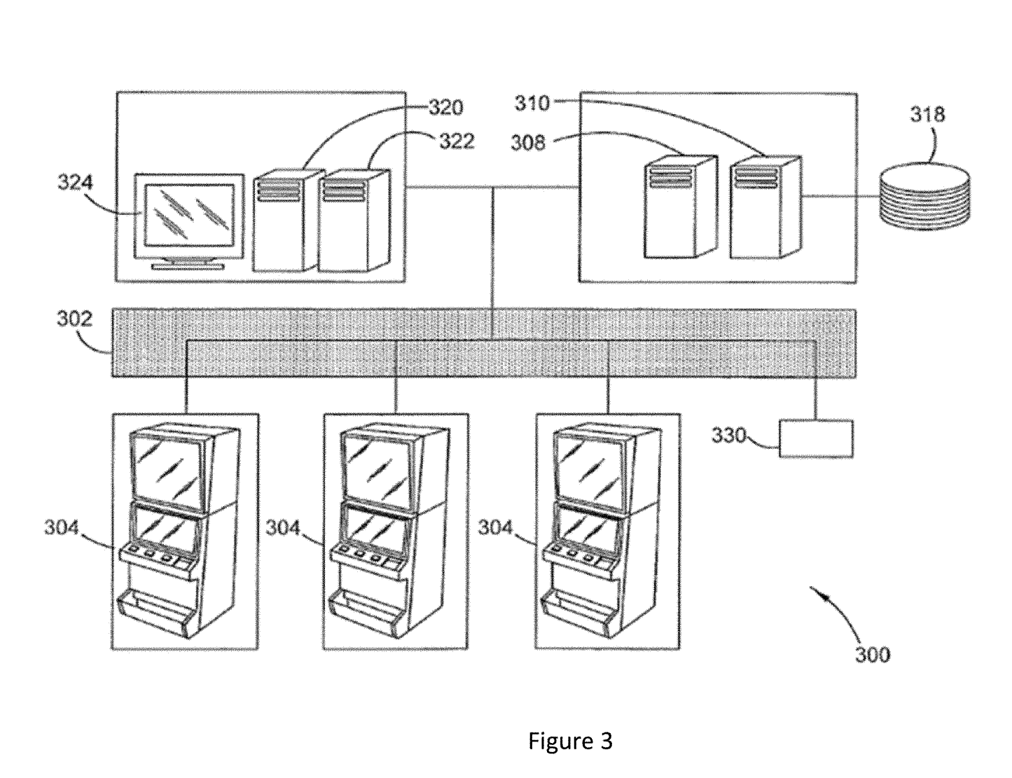

FIG. 3 shows a gaming system 300 in accordance with an alternative embodiment. The gaming system 300 includes a network 302, which for example may be or include an Ethernet, powerline, multimedia over Coax (MoCA), WiFi, or other type of network. The network 302 may also comprise a wide area network (“WAN”), the plain-old-telephone-system (“POTS”), a local area network (“LAN”), a wireless LAN, the Internet, or any combination of these and other types of networks. Gaming machines 304 are connected to the network 302. The gaming machines 304 provide a player operable interface and may be the same as the gaming machines 100 shown in FIG. 1 or may have simplified functionality depending on the requirements for implementing game play.

Gaming machines 304 may include game logic circuitry 200 as described above with reference to FIG. 2. Gaming machines 304 may further include a console similar to console 102 which contains all or most components required to implement a game play whereby, at least during part of the game play, a player wins or loses a wager. Access to the components may be by way of a hinged door, which may be similar to hinged door 105. Mounted to the exterior of the console may be a display means in the form of at least one visual display unit, which may be similar to display unit 104, on which one or more games is played. The display unit may be implemented as a liquid crystal display, a plasma screen, or other high quality digital video display. There may be more than one visual display unit on each gaming machine 304. For example, in some embodiments, gaming machines 304 may have one visual display unit for displaying the game being played, and at least one secondary display unit 120. Secondary display unit 120 may display artwork and advertising, as well as jackpot amounts, as illustrated in FIGS. 6 to 12 and described in further detail below. The units 104 and 120 may be implemented as a liquid crystal display, a plasma screen, or other high quality digital video display. What is displayed on the visual display unit will depend on what the intended goal of the unit is in relation to the player and any other potential participants in the gaming system. In some embodiments, a plurality of gaming machines 304 may communicate with a central display screen (not shown), which may allow for portions of gameplay to be displayed to a wider audience in a gaming venue.

Gaming machines 304 may include a tactile input for a player to interact via touch with the gaming machines 304. The tactile input may be in the form of a combination of pushbuttons and a touch screen similar to push-buttons 106 and a touch screen 108, for enabling a player to play one or more games. The touch screen may be an electronic visual display that can detect the presence and location of a touch within the display area. The touch screen may be used during game setup, user browsing, or during the game play between start of a game and the end of a game, for example. Certain functions of the pushbutton may include: initiation of game play, credit output, gameplay selection, completion of gameplay etc. A midtrim of the machine 304, similar to midtrim 112, may house the push-buttons.

The tactile input may optionally or further include a joystick comprising a stick that pivots on a base and reports its angle or direction to the device it is controlling. The tactile input may optionally or further include a trackpad/touchpad being a pointing device featuring a tactile sensor to translate the motion and position of a user's fingers to a relative position on screen. In some embodiments, tactile input may further include a keyboard, electronic mouse, or other input mechanism. In some embodiments, the user interface may be a user configurable interface having multiple user input options.

The midtrim of gaming machine 304 may house a credit input mechanism including a bill collector, similar to credit input mechanism 221 and bill collector 114. The credit input mechanism may alternatively or additionally include a coin input chute, a card and/or ticket reader, a magnetic reading head for reading a magnetic stripe card, an electronic reader for a proximity card, a near field communications reader or any other form of electronic, wireless or contact that can input credit to the gaming machine.

A payout mechanism including a coin tray, similar to payout mechanism 225 and coin tray 116, may be mounted beneath the console and may be provided for cash or other payouts from the machine 1304 to the player. A hopper device may be provided which dispenses coins, or tokens equal to the amount of credit currently on the machine, into the coin tray. Aside from the coin tray, the payout mechanism may alternatively or additionally include a ticket dispenser for issuing a ticket dispensed by a printer which the user can redeem for cash, a note dispenser, a near field communications transmitter or means to enable remote credit transfer. Other suitable payout mechanisms, such as fund transfers to the player's electronically recordable identification card or smart card, may be implemented in accordance with described embodiments.

The gaming machines 304 further include an auditory unit in the form of auditory output 208 (see FIG. 2) to provide auditory feedback to the player of the gaming machine 304.

In a thick client embodiment, game server 308 implements part of the game played by a player using a gaming machine 304 and the gaming machine 304 implements part of the game. With this embodiment, as both the game server 308 and the gaming machine 100 implement part of the game, they collectively provide a game controller having similar functions to controller 201. A database management server 310 may manage storage of game programs and associated data for downloading or access by the gaming devices 304 in a database 318.

In a thin client embodiment, game server 308 implements most or all of the game played by a player using a gaming machine 304 and the gaming machine 304 essentially provides only the player interface. With this embodiment, the game server 308 provides the game controller. The gaming machine 304 will receive player instructions, pass these to the game server 305 which will process them and return game play outcomes to the gaming machine 304 for display. In a thin client embodiment, the gaming machines could be computer terminals, e.g. PCs running software that provides a player interface operable using standard computer input and output components.

Additional servers may be provided to assist in the administration of the gaming network 300, including for example a gaming floor management server 320, and a licensing server 322 to monitor the use of licenses relating to particular games. An administrator terminal 324 is provided to allow an administrator to run the network 302 and the devices connected to the network.

The gaming system 300 may communicate with other gaming systems, other local networks, for example a corporate network, and/or a wide area network such as the Internet, for example through a firewall 330.

In some embodiments, functionality at the server side of the network may be distributed over a plurality of different physical computers. For example, functional software elements may be run as a single “engine” on one server or a separate server may be provided. For example, the game server 308 could run a random number generator engine. Alternatively, a separate random number generator server could be provided. Further, in some embodiments a plurality of game servers could be provided to run different games or a single game server may run a plurality of different games as required by game machines 304.

A functional block diagram 400 illustrating software components of gaming machine 100 is shown in FIG. 4. Memory 204 is accessible to processor 202 and stores game software module 231, which comprises a number of code modules executable by processor 202. Memory 204 also stores various game data accessible to processor 202. According to some embodiments, some of the data illustrated as stored in memory 204 may alternatively be stored on a memory device external to but accessible by gaming machine 100 and processor 202, such as on a server.

Game data stored by memory 204 includes symbol data 401, pay-table data 402, denomination data 403, jackpot data 404, and jackpot start-up data 405. Symbol data 401 may include data relating to the symbols to be displayed on visual display unit 104 of gaming machine 100 by processor 202 during a game. For example, the particular images used for each symbol may be stored, as well as an identification code relating to the symbol, and a value of the symbol.

Pay-table data 402 may include data relating to a pay-table used in the game played on gaming machine 100. Pay-table data 402 may be used by processor 202 to calculate whether one or more winning events has occurred on gaming machine 100. Winning events may include jackpot winning events, as well as other winning events. Pay-table data 402 may be used by processor 202 to determine the amount won based on which combination of symbols appear on visual display unit 104, including whether a jackpot amount has been won. Pay-table data 402 may be related to symbol data 401, as the amount won by a player is determined by processor 202 based on the value of the symbols as stored in symbol data 401.

Denomination data 403 may store possible denomination amounts for betting by a player to initiate a game on gaming machine 100. A denomination amount may be a value of 1 credit. For example, in some embodiments a “1c” denomination will mean that 1 credit equals one cent. In this case, when a player elects to play 60 lines at 1 credit bet per line, they bet 60c. A denomination of “5c” may mean that 1 credit equals five cents. In this case, if a player elects to play 20 lines at 2 credits bet per line, the wager is 40 credits, or $2.00. Denomination data 403 may store the number of denominations available, as well as the bet value for each denomination. For example, denomination data 403 for one example gaming machine 100 may store three denominations, being 1c, 2c and 5c. In another example denomination data 403 for a second example gaming machine 100 may store four denominations, being 1c, 2c and 5c and 10c. Once a player has started a game on gaming machine 100, processor 202 may also store the current denomination value being played by the player in denomination data 403.

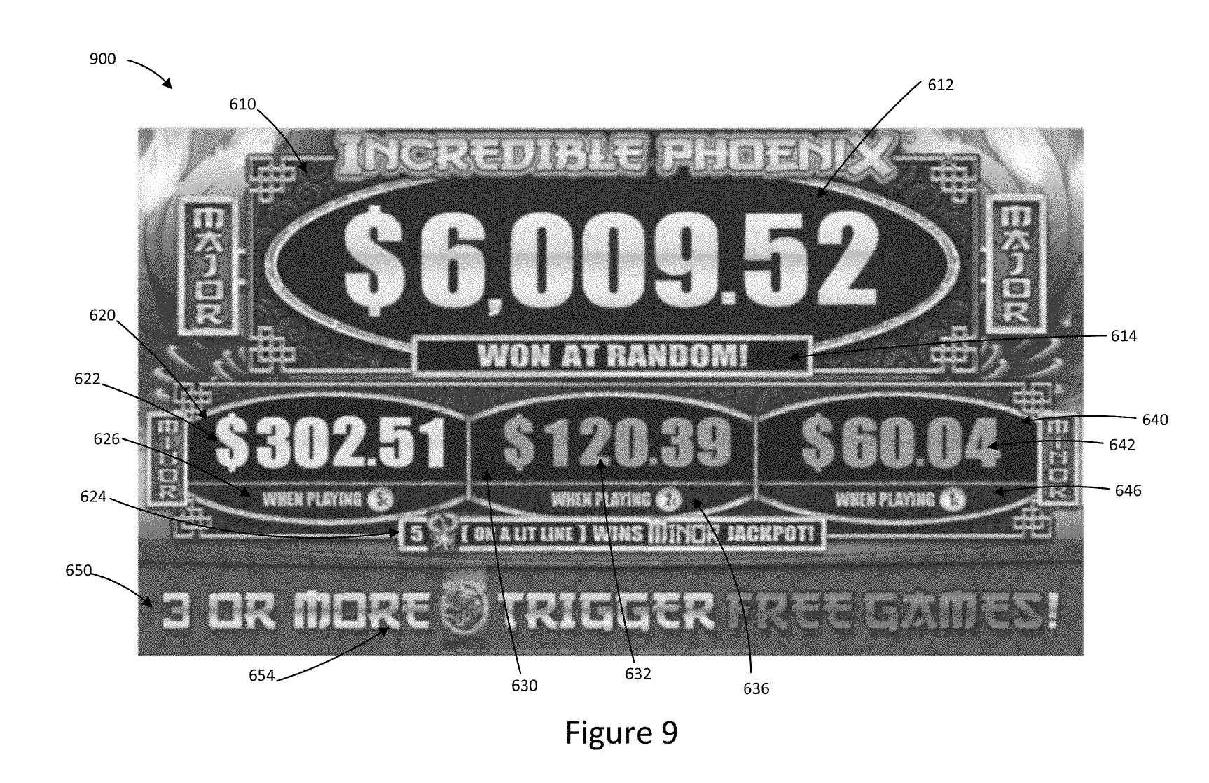

Jackpot data 404 may store information relating to one or more jackpots made available by gaming machine 100. Jackpot data 404 may store the number of jackpots available, and the current amount of each available jackpot. Jackpot data 404 may include data for major jackpots, as well as for minor jackpots. According to some embodiments, major jackpots may be shared across all bet denominations, and minor jackpots may be exclusive to one bet denomination each. In some embodiments, minor jackpots may be shared across all bet denominations, and major jackpots may be exclusive to one bet denomination each. According to some embodiments, jackpot data 404 may store information relating to all least one shared jackpot, and at least two denomination-specific jackpots. For example, jackpot data 404 for an example gaming machine 100 may store one shared jackpot, which may be $6,009.52, and three denomination-specific jackpots, which may be $302.51, $120.39, and $60.04, as shown in FIG. 9. The major (and shared) jackpot may be maintained by the jackpot increment and reset modules to always be higher, and possibly significantly higher, than the minor (denomination-specific) jackpots. Jackpot data 404 may be incremented by processor 202 when user input component 216 receives an input indicating that a player has placed a bet. The increment amount may depend on the value of the bet placed by the player. Jackpot data 404 may be linked to denomination data 403, as each denomination-specific jackpot amount may be associated with a corresponding denomination amount. Once a player has started a game on gaming machine 100, processor 202 may also write the current denomination-specific jackpot available to the player based on the current denomination value being played by the player to jackpot data 404.

Jackpot start-up data 405 may store information relating to the start-up, base, “seed” or reset values for each jackpot stored in jackpot data 404. When a jackpot is won by a player, the jackpot amount stored in jackpot data for that jackpot may be reset by processor 202 to the jackpot start-up amount stored in jackpot start-up data associated with the corresponding jackpot. For example, jackpot start-up data may store a start-up value of $6000.00 for a shared jackpot, and start-up values of $300.00, $120.00, and $60.00 for first, second and third denomination-specific jackpots, respectively, as shown in FIG. 6. If the second jackpot is won, for example, the jackpot amount stored in jackpot data 404 for the second jackpot may be updated to be $120.00 by processor 202.

In some embodiments, code modules within game software module 231 may include game module 411, jackpot increment module 412, and jackpot reset module 413.

Game module 411 may be executable by processor 202 to cause a game, which may be a reel-type game in some embodiments, to be displayed on visual display unit 104. The game may be any chance-based game, in which a symbol sub-set, such as a two-dimensional array of symbols, is randomly selected from a larger symbol set for display on visual display unit 104, with or without the appearance of spinning reels. The symbol set from which the displayed symbol subset is randomly selected for the game by processor 202 is sized to permit a reasonable degree of variation among the selected symbols across a significant number of instances of symbol sub-set generation. The symbol sub-set may include multiple instances of the same symbol.

Game module 411 may be executed by processor 202 when a player initiates game play using user input 218. Game module 411 may allow a player to make a bet or wager using credit input mechanism 221, input mechanisms 106, and user input 218, and may determine a random game outcome using random number generator 210. Executing game module 411 may cause processor 202 to determine whether the player won any credits or other awards using base-game pay-table data 402. Processor 202 may then cause gaming machine 100 to credit the player with any winnings using payout mechanism 225.

Jackpot increment module 412 may be executable by processor 202 to cause a jackpot amount, as stored in jackpot data 404, to be incremented based on an amount bet by a player. Jackpot increment module 412 may be executed by processor 202 when a player initiates game play using user input 218 and makes a bet or wager using credit input mechanism 221, input mechanisms 106, and user input 218. Jackpot increment module 412 may determine an amount that one or more of the jackpot amounts stored in jackpot data 404 should be incremented, based on an amount bet or wagered.

According to some embodiments, the amount that one or more of the jackpot amounts stored in jackpot data 404 should be incremented is a predetermined proportion of the amount bet or wagered. For example, for a denomination-specific jackpot, the predetermined proportion may be 1%, 5%, 10%, 15%, 20%, or more of the amount bet or wagered, according to some embodiments. For example, if $1.00 is bet or wagered for one game, according to some embodiments jackpot increment module 412 may increment the currently selected denomination-specific jackpot by 10c, and may retain 90c for the “house” or the organisation running gaming machine 100 and other purposes.

According to some embodiments, when a bet is made, the currently selected denomination-specific jackpot may be incremented by a small predetermined proportion of the wager, a slightly larger predetermined proportion of the wager of the wager may be used to fund the start-up or seed component for the selected jackpot, an even larger predetermined proportion of the wager may be used to fund a shared jackpot, a majority predetermined proportion of the wager may be used to fund non-jackpot winning events, and the remaining proportion of the wager may be used to retained as the house profit.

For example, if $1.00 is bet or wagered, the currently selected denomination-specific jackpot may be incremented by 1c (1%), and the other 99% may be reserved by gaming machine 100. The reserved 99c may be used to fund one or more of the start-up or seed component for the selected jackpot, a shared jackpot, non-jackpot winning events, and house profit. For example, according to some embodiments, 2% or 2c of the wager may be used to fund the start-up or seed component for the selected jackpot, 3% or 3c of the wager may be used to fund a shared jackpot, 85% or 85c may be used to fund non-jackpot winning events, and 9% or 9c of the wager may be used to retained as the house profit.

In an alternative embodiment, if $1.00 is bet, and jackpot data 404 stores data for three denomination-specific jackpots and one shared jackpot, jackpot increment module 412 may increment one denomination-specific jackpot by 10c, one denomination-specific jackpot by 15c, one denomination-specific jackpot by 20c, and the shared jackpot by 25c, for example. 30c may be kept by the house as a profit from the game. The predetermined proportion of the bet amount that is added to each of the jackpots may be proportional to the corresponding denomination amount. For example, a jackpot amount stored in relation to a 1c denomination may be incremented by 10% of each bet amount placed by the player, while a jackpot amount stored in relation to a 2c denomination may be incremented by 20% of each bet amount placed by the player. The particular percentages or proportions of each wager that are retained by the house or used to increment the jackpot or jackpots may be determined based on jurisdictional regulations.

According to some embodiments, jackpot increment module 412 may only increment the jackpot or jackpots and retain money for the house if the game played does not yield a payout event, such as a jackpot winning event, and may return the amount wagered back to the player if a payout event occurs. In some embodiments, jackpot increment module 412 may increment jackpot or jackpots and retain money for the house regardless of whether the game played yields a payout event or not.

Jackpot reset module 413 may be executable by processor 202 to cause the jackpot amounts stored in jackpot data 404 to be reset with the values stored in jackpot start-up data 405. Jackpot reset module 413 may be executed when game module 411 determines, based on reel symbol data 401 and pay-table data 402, that a jackpot has been won. The corresponding jackpot amount, as stored in jackpot data 404, is paid out to the player using payout mechanism 225. Jackpot reset module 413 then causes jackpot data 404 for the corresponding jackpot amount to be reset to the value stored in jackpot start-up data 405 for the denomination amount currently being played by the player.

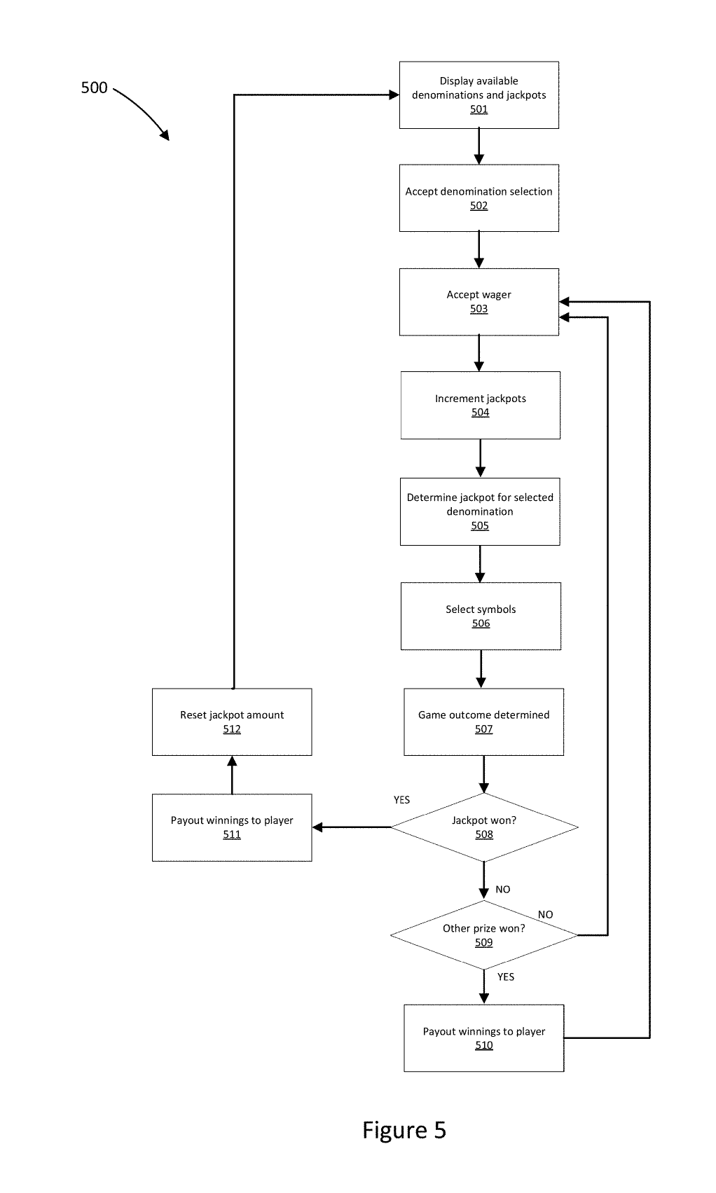

Referring now to FIG. 5, there is shown a flow diagram illustrating a method 500 of gaming by implementing a game at a gaming system, such as gaming machine 100 illustrated in FIG. 1 and gaming machines 304 illustrated in FIG. 3.

The method 500 of gaming may comprise an initial step 501 of gaming machine 100 displaying two or more available denominations and wagers on secondary display unit 120. Processor 202 may retrieve the values to be displayed from denomination data 403 and jackpot data 404. If a player selects a displayed denomination and jackpot using touchscreen 108, at step 502 gaming machine 100 receives the selection. Processor 202 may write the selected denomination and the corresponding jackpot value to denomination data 403 and jackpot data 404, respectively. According to some embodiments, gaming machine 100 may also display at least one shared jackpot.

At step 503, game module 411 is initiated by processor 202 in response to receiving a wager placed by a player via user input 118. Gaming machine 100 accepts the wager amount, and at step 504 the bet or wager amount is used to increment one or more of the jackpots stored in jackpot data 404. As described above, according to some embodiments the amount of the bet allocated to each jackpot may be proportional to the denomination associated with the particular jackpot. Some of the wager may also be kept by the house, being the business or establishment that owns and/or controls gaming machines 100/304. The amount kept by the house may be varied based on the regulatory rules in the jurisdiction the game is being played in.

At step 505, processor 202 determines at least one jackpot that is to be made accessible to the player, based on the selected denomination, and highlights the selected jackpots and denomination, as described below with reference to FIGS. 6, 7 and 8. The available jackpots may include one denomination-specific jackpot, according to the selected denomination, as well as at least one shared jackpot, that may be made available regardless of the selected denomination. Processor 202 may access denomination data 403 to determine what denomination has been selected, and may further access jackpot data 404 to determine the denomination-specific jackpot associated with the selected denomination.

At step 506, game module 411 is executed by processor 202 to cause a plurality of symbols derived from symbol data 401 to be selected by processor 202 for display at a plurality of display positions on a visual display unit 104. In some embodiments, where the game is a reel game, game module 411 may be executed by processor 202 to cause the reels to appear to virtually spin on visual display unit 104. The selection of the symbols may be performed randomly, for example by the random number generator 414. Jackpot data as shown, for example, in FIGS. 6, 7, and 8 continues to be displayed on secondary display unit 120.

In a further step 507, a game outcome is determined based on the randomly displayed symbols on the display. The game outcome may be determined by processor 202 based on pay-table data 402.

At step 508, processor 202 determines whether or not a jackpot has been won, based on the particular symbols displayed on visual display unit 104 and based on pay-table data. If no jackpot has been won, then based on pay-table data 402, processor 202 determines whether any other rewards have been won at step 509. If nothing has been won, method 500 continues to step 503, where a player can elect to place a further wager. If a game outcome results in the winning of a monetary award, this may be credited to the player through payout mechanism 225 at step 510. In some embodiments, the amount won may be stored and accumulated during the game session, and the total amount may be awarded at the end of the game session. The amount won may be awarded as cash, or as credits that can be redeemed for cash. Method 500 then continues to step 503, where a player can elect to place a further wager.

If a game outcome results in the winning of either a denomination-specific jackpot or a shared jackpot at step 508, this may be credited to the player through payout mechanism 225 at step 511. The jackpot amount is read from jackpot data 404. In some embodiments, the amount won may be stored and accumulated during the game session, and the total amount may be awarded at the end of the game session. The amount won may be awarded as cash, or as credits that can be redeemed for cash.

At step 512, processor 202 resets the jackpot amount, by reading jackpot start-up data 405 and writing the corresponding jackpot value to jackpot data 404. The method then continues to step 501, by displaying the available denominations and jackpots to allow a player to select a new denomination to wager.

A specific example of the method 500 of gaming is described below with reference to screenshots of the display of the gaming system 100 shown in FIGS. 6 to 12.

FIGS. 6 to 8 show example screenshots 600, 700 and 800 that may be displayed by gaming machine 100 on secondary display unit 120. Screenshots 600, 700 and 800 show a shared jackpot, being major jackpot 610 and three denomination-specific jackpots, being a first minor jackpot 620, a second minor jackpot 630 and a third minor jackpot 640. Major jackpot 610 shows a jackpot amount 612 and a jackpot condition 614. Jackpot amount 612 may be retrieved by processor 202 from jackpot data 404, while jackpot condition 614 may be retrieved by processor 202 from pay-table data 402. In the illustrated embodiments, jackpot amount 612 shows $6008.68, indicating the amount of money to be won if major jackpot 610 is triggered. In the illustrated embodiment, the jackpot condition 614 displays the text “won at random”, indicating that major jackpot 610 is won based on a random result generated by random number generator 210. According to some embodiments, jackpot condition 614 may display a different condition, such as a particular number of symbols appearing on a particular line, for example.

Minor jackpots 620, 630 and 640 each also show a jackpot amount, being first jackpot amount 622, second jackpot amount 632 and third jackpot amount 642. A single jackpot condition 624 is shown, which in the illustrated embodiment indicates that five of a particular symbol on a lit line will trigger a minor jackpot. Jackpot amounts 622, 632 and 642 may be retrieved by processor 202 from jackpot data 404, while jackpot condition 624 may be retrieved by processor 202 from pay-table data 402. In the illustrated embodiment, jackpot amounts 622, 632 and 642 shows $300.00, $120.00 and $60, respectively. These amounts may correspond to the “start-up” amounts for each jackpot, as retrieved by processor 202 from jackpot start-up data 405.

Minor jackpots 620, 630 and 640 also each show a denomination amount, being a first denomination amount 626, a second denomination amount 636 and a third denomination amount 646. In the illustrated embodiment, first minor jackpot 620 relates to a first denomination amount 626 of 5c, second minor jackpot 630 relates to a second denomination amount 636 of 2c, and third minor jackpot 640 relates to a third denomination amount 646 of 1c. The denomination amounts may be retrieved by processor 202 from denomination data 403.

Screenshot 600 further shows a bonus feature 650, which includes a bonus condition 652. In the illustrated embodiment, bonus feature 650 is a “giant spin” bonus, and the condition indicates that four of a particular symbol on a lit line will trigger the bonus feature.

Screen 600 may be displayed to a user at step 501 of method 500, allowing a user to select a denomination and a corresponding jackpot amount to play. Before a player makes a selection, each of jackpots 620, 630 and 640 may be displayed highlighted or otherwise visually emphasised relative to the surrounding graphical elements on the display. Once gaming machine 100 received a denomination selection at step 502 of method 500, processor 202 causes the unselected jackpots to be greyed out, un-highlighted, or otherwise visually distinguished from the selected jackpot.

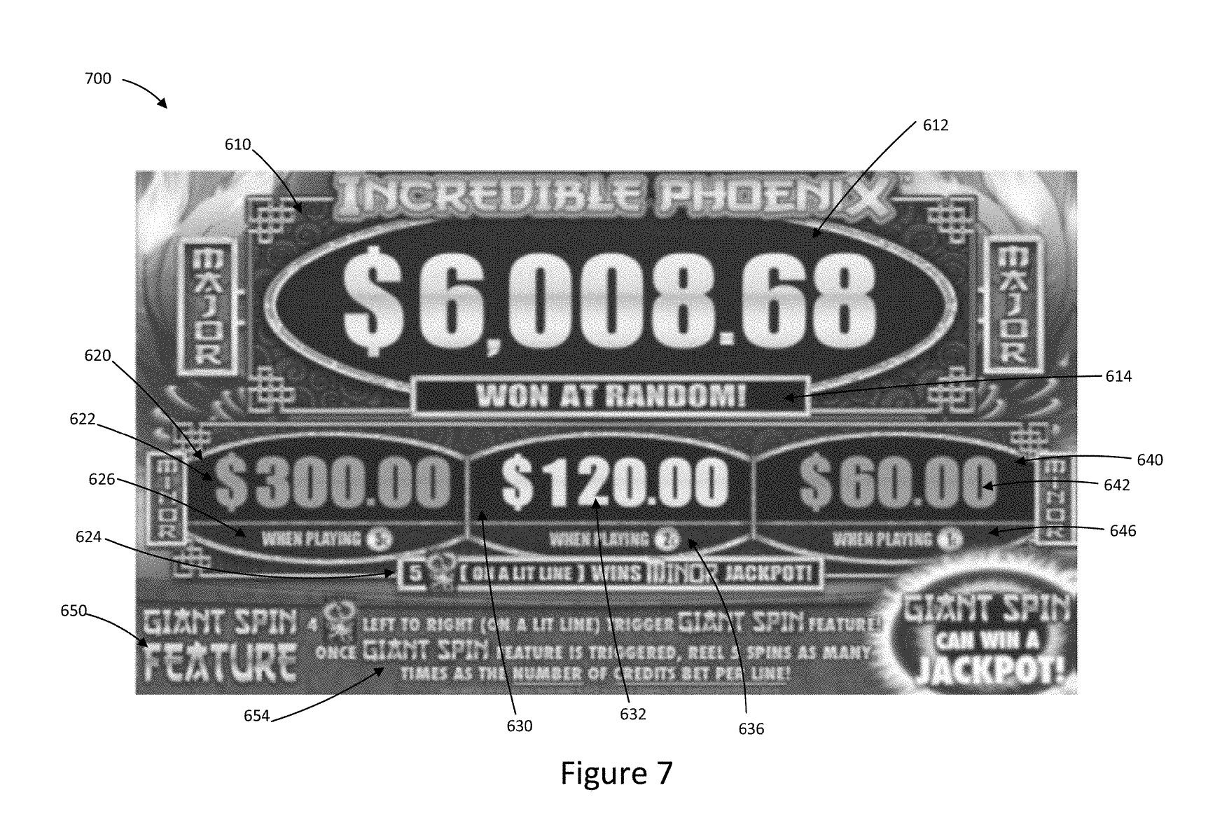

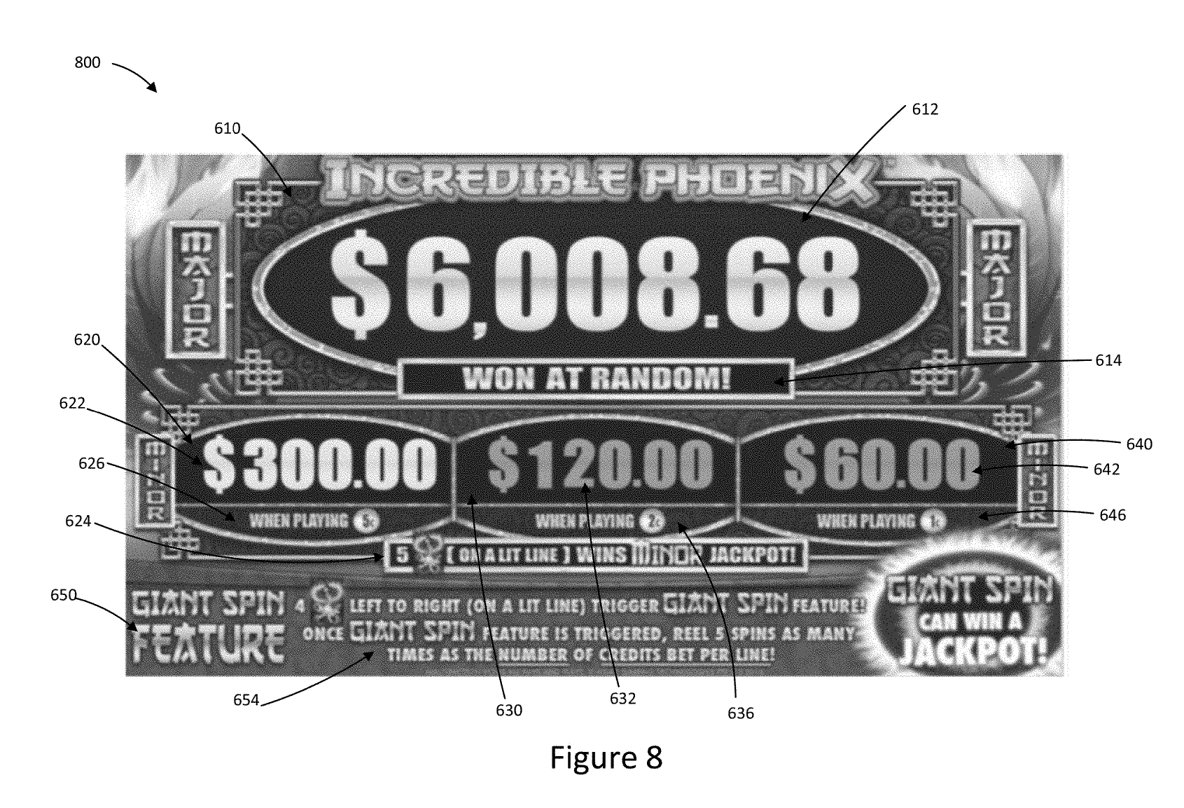

In the illustrated embodiment shown in FIG. 6, jackpot 640 has been selected and remains highlighted or otherwise emphasised, while unselected jackpots 620 and 630 appear dull, greyed out or un-highlighted. In the illustrated embodiment shown in FIG. 7, jackpot 630 has been selected and remains highlighted, while unselected jackpots 620 and 640 appear dull, greyed out or un-highlighted. In the illustrated embodiment shown in FIG. 8, jackpot 620 has been selected and remains highlighted, while unselected jackpots 630 and 640 appear dull, greyed out or un-highlighted. In each of FIGS. 7 to 8, major jackpot 610, being a shared jackpot across each denomination, remains highlighted.

When gaming machine 100 accepts a wager at step 503 of method 500, the jackpot for the denomination selected at step 502 will increment by an amount known as a jackpot contribution. For example, if the jackpot contribution percentage is 0.5, and a player places a $4 bet when playing 5c denomination, the jackpot would increment by 2 cents. According to some embodiments, there are no cross-contributions between the three jackpots. However, according to some embodiments, as described above, a wager when playing one denomination may be split to increment all jackpots. As further described above, some of the wager is also used to fund any shared jackpots, seed amounts, other winning events, and as house profit.

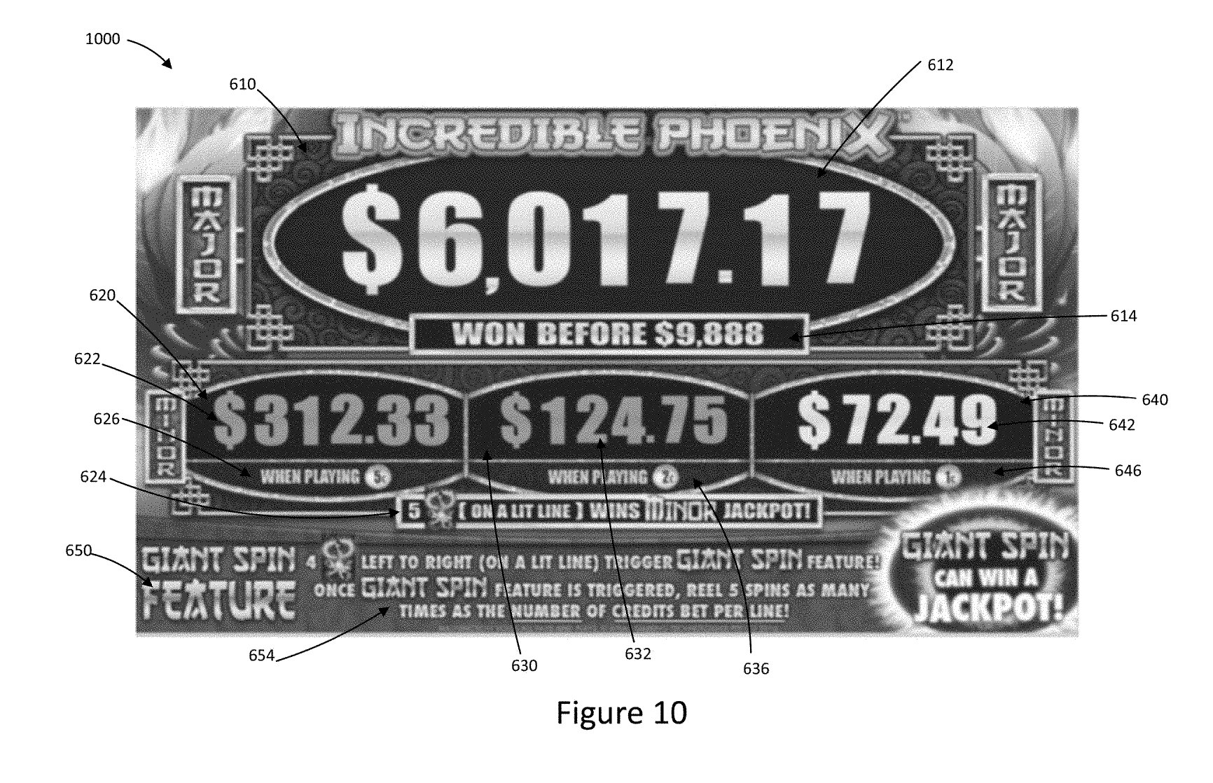

After one or more players have played different denominations on gaming machine 100 for some time without a jackpot-winning event occurring, all four jackpots 610, 620, 630 and 640 will have jackpot amounts 612, 622, 632 and 642 that are higher than the start-up amounts displayed in FIGS. 6, 7 and 8. For example, FIG. 9 shows a scenario where major jackpot 612 has been progressively incremented to $6009.52, and minor jackpots 620, 630 and 640 have been progressively incremented from the base (“seed”) amounts of $300.00, $120.00 and $60.00 to $302.51, $120.39 and $60.04, respectively. Jackpot 620 has been selected and remains highlighted, while jackpots 630 and 640 are deselected and un-highlighted. FIG. 10 shows a later or subsequent scenario where major jackpot 612 has been further progressively incremented to $6017.17, and minor jackpots 620, 630 and 640 have been further progressively incremented to $312.33, $124.75 and $72.49, respectively, from the jackpot amounts shown in FIG. 9, assuming that a jackpot winning event did not occur in between. Jackpot 640 has been selected and remains highlighted, while jackpots 620 and 630 are deselected and un-highlighted.

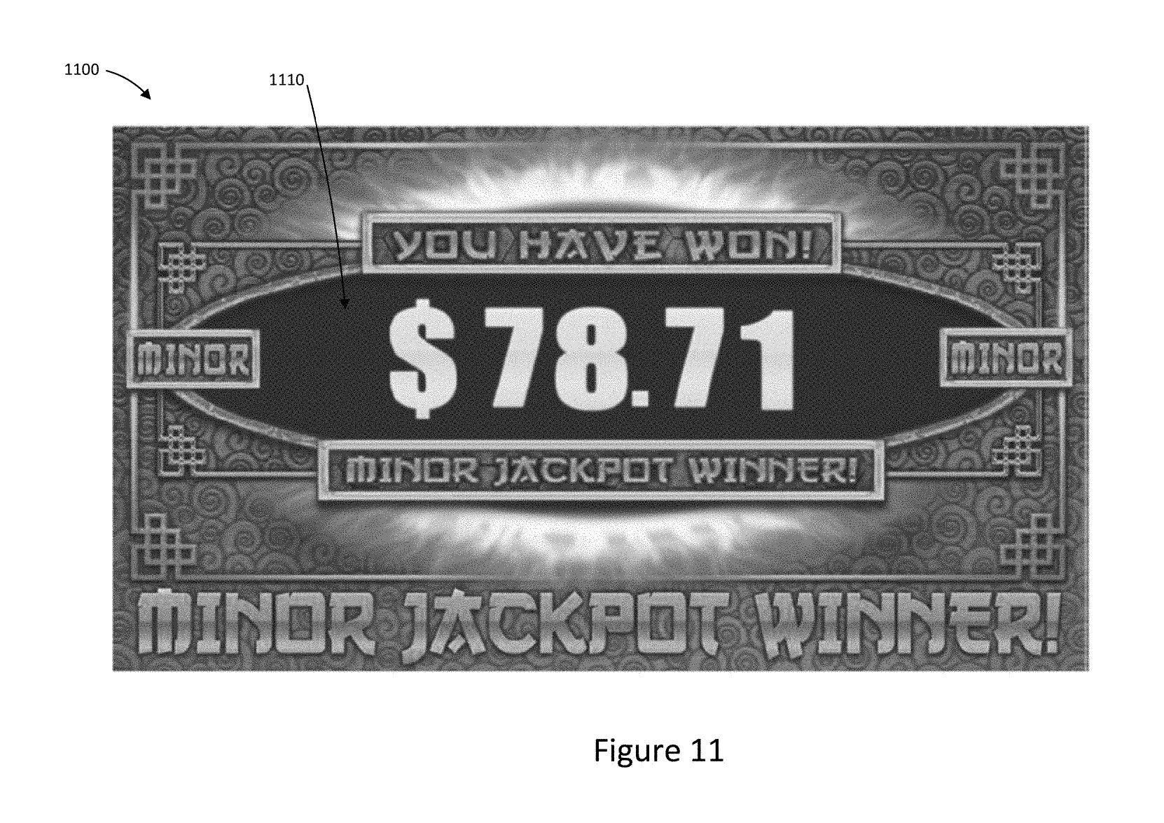

FIG. 11 shows an example screenshot 1100 that may be displayed by gaming machine 100 on secondary display unit 120 after a jackpot has been won by a player at step 508 of method 500. Screenshot 1100 shows the jackpot amount 1110 that has been won, being the amount that is to be paid out to the player at step 511. The jackpot amount is then reset at step 512.

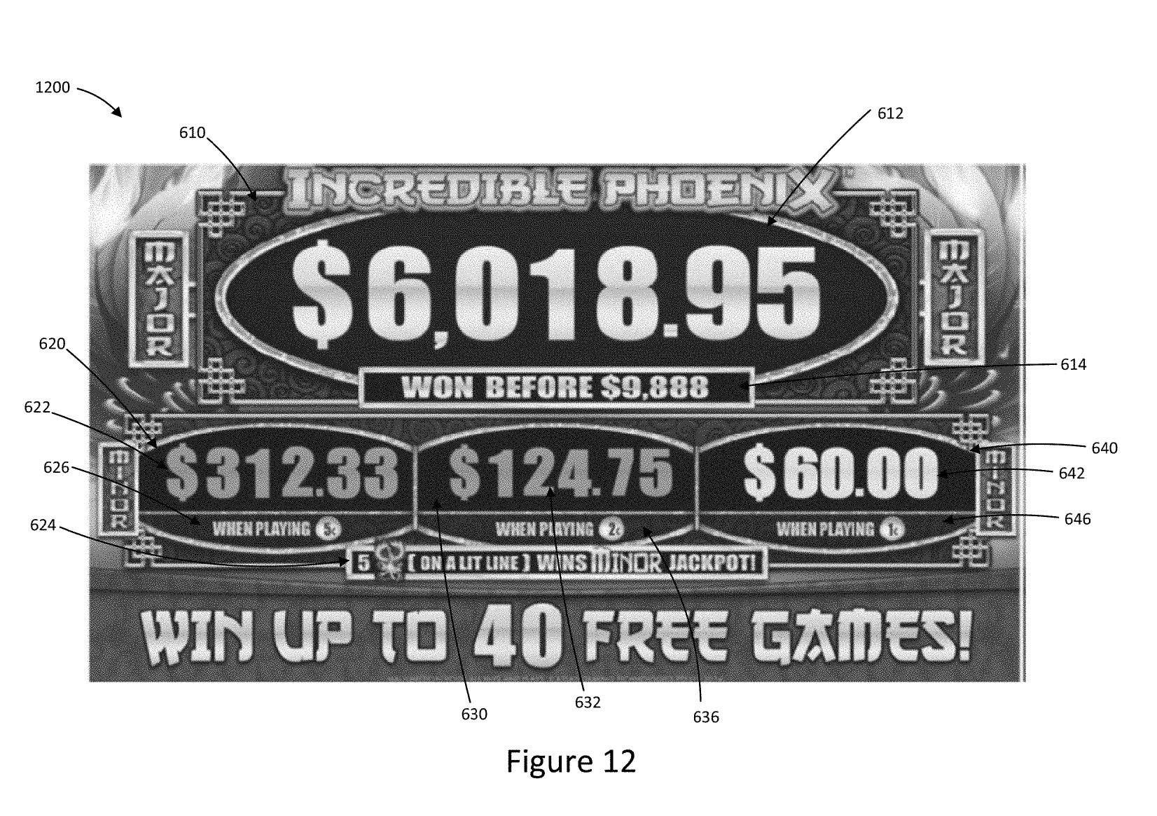

FIG. 12 shows an example screenshot 1100 that may be displayed by gaming machine 100 on secondary display unit 120 after a jackpot has been reset at step 512 of method 500, and the gaming machine displays available denominations to the player at step 501. In the illustrated embodiment, jackpot 640 has been won and reset to a start-up value of $60.00 by processor 202. However, jackpots 620 and 630 have jackpot amounts higher than their respective start-up or “seed” values.

In some previously known gaming machines, once a jackpot is won a player may be deterred from continuing to play at the gaming machine, as the jackpot value will be reset to a lower amount. The player may seek a gaming machine that already displays a higher jackpot. However, in the gaming machine of the present application, a player is motivated to continue playing due to the one or more additional jackpots displayed on gaming machine 100. For example, once a player has won one jackpot 640 for one betting or wagering denomination, as illustrated, the player may elect to play a different jackpot 620 or jackpot 630 for a different denomination.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

1. A gaming machine, comprising:
at least one processor;
memory storing executable program code;
at least one display to display game-related images; and
input components to receive player input;
wherein the at least one processor is configured to execute the program code to:
implement and display at least two denomination-specific jackpots and at least one shared jackpot to a user on a first area of the at least one display;
display at least two bet denominations to the user, each bet denomination corresponding to at least one of the at least two denomination-specific jackpots;
in response to receiving first input from the user, determine one bet denomination to be a selected bet denomination;
determine at least one denomination specific-jackpot corresponding to the one bet denomination to be a first selected jackpot;
in response to receiving second input from the user, display a game of chance on a second area of the at least one display while simultaneously displaying the at least two denomination-specific jackpots and the at least one shared jackpot to a user on the first area of the at least one display;
in response to determining a denomination-specific jackpot-winning game outcome, award the user the selected jackpot; and
in response to determining a shared jackpot-winning game outcome, award the user at least one shared jackpot.

2. The gaming machine of claim 1, wherein receiving second input from the user comprises receiving a wager from the user.

3. The gaming machine of claim 2, wherein the gaming machine further comprises a currency acceptance mechanism and is configured to receive credit via the currency acceptance mechanism.

4. The gaming machine of claim 2, wherein the processor is further configured to use a portion of the wager to increment at least one denomination-specific jackpot, to implement the denomination-specific jackpot as a progressive jackpot.

5. The gaming machine of claim 2, wherein the processor is further configured to use a portion of the wager to increment at least one shared jackpot, to implement the shared jackpot as a progressive jackpot.

6. The gaming machine of claim 2, wherein the processor is further configured to use a portion of the wager to fund at least one seed value corresponding to at least one shared or denomination-specific jackpot.

7. The gaming machine of claim 6, wherein, in response to awarding the user the selected jackpot, the processor is further configured to set the jackpot value of the selected jackpot to the seed value corresponding to the selected jackpot.

8. The gaming machine of claim 6, wherein, in response to awarding the user at least one shared jackpot, the processor is further configured to set the jackpot value of the at least one shared jackpot to the seed value corresponding to the at least one shared jackpot.

9. The gaming machine of claim 1, wherein the at least one display comprises two displays, where the first area of the at least one display is located on a first display of the two displays and the second area of the at least one display is located on a second display of the two displays.

10. The gaming machine of claim 1, wherein the at least two denomination-specific jackpots comprise three denomination-specific jackpots and the at least two bet denominations comprise three bet denominations.

11. The gaming machine of claim 1, wherein the at least two denomination-specific jackpots comprise four denomination-specific jackpots and the at least two bet denominations comprise four bet denominations.

12. A computer implemented method of operating a gaming machine, the method comprising:
implementing and displaying at least two denomination-specific jackpots and at least one shared jackpot to a user on a first area of at least one display on the gaming machine;
displaying at least two bet denominations to the user, each bet denomination corresponding to at least one of the at least two denomination-specific jackpots;
in response to receiving input from the user, determining one bet denomination to be a selected bet denomination;
determining at least one denomination specific-jackpot corresponding to the one bet denomination to be a first selected jackpot;
in response to receiving input from the user, displaying a game of chance on a second area of the at least one display while simultaneously displaying the at least two denomination-specific jackpots and the at least one shared jackpot to a user on the first area of the at least one display;
in response to determining a denomination-specific jackpot-winning game outcome, awarding the player the selected jackpot; and in response to determining a shared jackpot-winning game outcome, awarding the player at least one shared jackpot.

13. The method of claim 12, wherein receiving second input from the user comprises receiving a wager from the user.

14. The method of claim 12, further comprising receiving credit via a currency acceptance mechanism.

15. The method of claim 13, further comprising using a portion of the wager to increment at least one denomination-specific jackpot to implement the denomination-specific jackpot as a progressive jackpot.

16. The method of claim 13, further comprising using a portion of the wager to increment at least one shared jackpot to implement the shared jackpot as a progressive jackpot.

17. The method of claim 13, further comprising using a portion of the wager to fund at least one seed value corresponding to at least one shared or denomination-specific jackpot.

18. The method of claim 17, further comprising, in response to awarding the user the selected jackpot, setting the jackpot value of the selected jackpot to the seed value corresponding to the selected jackpot.

19. The method of claim 17, further comprising, in response to awarding the user at least one shared jackpot, setting the jackpot value of the at least one shared jackpot to the seed value corresponding to the at least one shared jackpot.

20. The method of claim 12, wherein the at least one display comprises two displays, where the first area of the at least one display is located on a first display of the two displays and the second area of the at least one display is located on a second display of the two displays.

21. The method of claim 12, wherein the at least two denomination-specific jackpots comprise three denomination-specific jackpots and the at least two bet denominations comprise three bet denominations.
